(19) United States
(12) Patent Application Publication
(10) Pub. No.: US 2026/0231927 A1
(43) Pub. Date: Aug. 13, 2026

(54) MOBILE HUNTING STAND CONVERTIBLE TO TRAILER

(71) Applicant: Nicola DiPardo, Bolton (CA)

(72) Inventor: Nicola DiPardo, Bolton (CA)

(21) Appl. No.: 19/313,274

(22) Filed: Aug. 28, 2025

(30) Foreign Application Priority Data
Sep. 9, 2024 (CA) 3254092

(51) Int. Cl. A01M 31/02; B60P 3/34; B60R 3/02

(52) U.S. Cl. CPC A01M 31/02; B60P 3/34; B60R 3/02

(57) ABSTRACT

A mobile hunting stand convertible from a disassembled configuration in the form of trailer and an assembled configuration as an elevated hunting platform, having a platform supported by a frame, a set of wheels operatively connected to the frame and 5 configured to be elevated off the ground when the platform and frame are in an assembled configuration as the hunting stand, and to support the frame when in a disassembled configuration as a trailer. The mobile hunting stand also provided with a hitch mechanism attached to the frame for connection to a vehicle for towing the mobile hunting stand in the disassembled configuration. The mobile hunting stand 10 has a plurality of adjustable legs detachably connectable to the frame to enable rapid assembly and disassembly and an adjustable ladder attachable to the frame when in the assembled configuration in order to provide access to the platform.

### FIELD OF THE INVENTION

The present invention relates to hunting equipment, specifically to a mobile hunting stand that can be converted into a trailer. This invention addresses the need for a versatile and efficient solution for hunters to access remote hunting locations and transport their equipment and game without the need for multiple vehicles or cumbersome setups.

### DESCRIPTION OF THE PRIOR ART

Hunting often requires accessing remote and difficult-to-reach locations, necessitating the transportation of equipment and game. Traditional stationary hunting stands require significant effort to transport and set up, often involving multiple vehicles. Hunters typically need to load their stationary stands onto transport vehicles, which can be cumbersome and time-consuming.

Existing solutions involve placing hunting stands on transport vehicles and driving them around properties. However, regulations prohibit hunting from apparatuses that are not securely grounded. This limitation creates a need for a more efficient and compliant solution that allows hunters to access remote locations, set up a stable hunting stand, and transport their game without the need for multiple vehicles or complex setups.

### SUMMARY OF THE INVENTION

According to one aspect of the present invention, a mobile hunting stand is provided that is convertible from a disassembled configuration in the form of trailer and an assembled configuration as an elevated hunting platform. The mobile hunting stand comprises a platform supported by a frame, a set of wheels operatively connected to the frame and configured to be elevated off the ground when the platform and frame are in an assembled configuration as the hunting stand, and to support the frame when in a disassembled configuration as a trailer;
a hitch mechanism attached to the frame for connection to a vehicle for towing the mobile hunting stand in the disassembled configuration;
a plurality of adjustable legs detachably connectable to the frame to enable rapid assembly and disassembly; and
an adjustable ladder attachable to the frame when in the assembled configuration in order to provide access to the platform.

According to another aspect, a mobile hunting stand comprises a frame with a plurality of adjustable legs detachably connectable to the frame to enable rapid assembly and disassembly, mobile hunting stand configured to be assembled into a hunting stand and disassembled into a trailer; a set of wheels attached to the frame, wherein the wheels are configured to be elevated off the ground when the adjustable legs are detachably connectable to the frame and to support the frame when disassembled into the trailer; a trailer hitch attached to the frame for towing the trailer; wherein the mobile hunting stand, when assembled, positions the wheels alongside a user at an elevated height.

According to yet another aspect, the mobile hunting stand includes cross-bracing for additional stability when used as a hunting stand.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a perspective drawing of one embodiment of a mobile hunting stand that can be converted into a trailer according to the present invention.

FIG. 2 is another perspective drawing of the mobile hunting stand of FIG. 1.

FIG. 3 is a perspective drawing of the mobile hunting stand of FIG. 1 disassembled in the form of a trailer towed by an ATV;

FIG. 4 is another perspective drawing of the mobile hunting stand disassembled in the form of a trailer of FIG. 3;

FIG. 5 is a perspective drawing of the mobile hunting stand disassembled in the form of a trailer of FIG. 3.

Similar references are used in different figures to denote similar components

### DETAILED DESCRIPTION OF THE PREFERRED EMBODIMENT

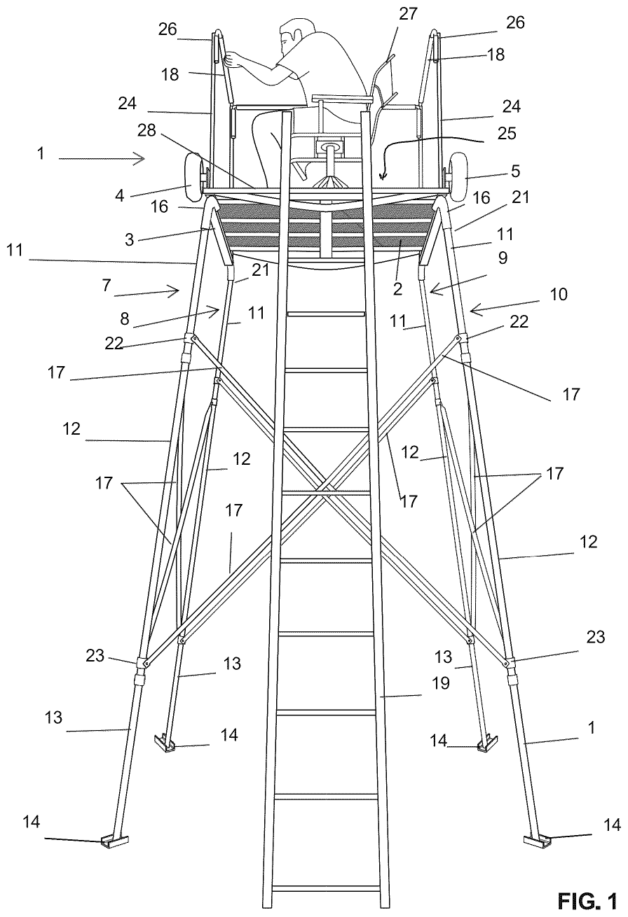

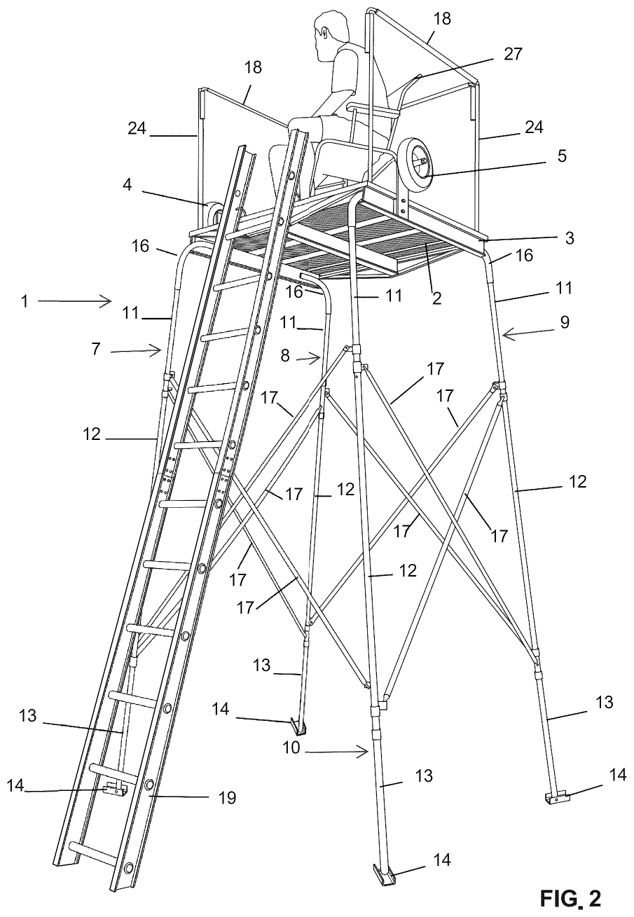

Referring to FIGS. 1 and 2, an embodiment of a mobile hunting stand is illustrated in its assembled state, ready for use as a hunting platform according to the present invention is generally indicated at 1. The mobile hunting stand 1 can be converted from this first configuration as an elevated hunting platform and dissembled to a second configuration as a trailer and vice versa.

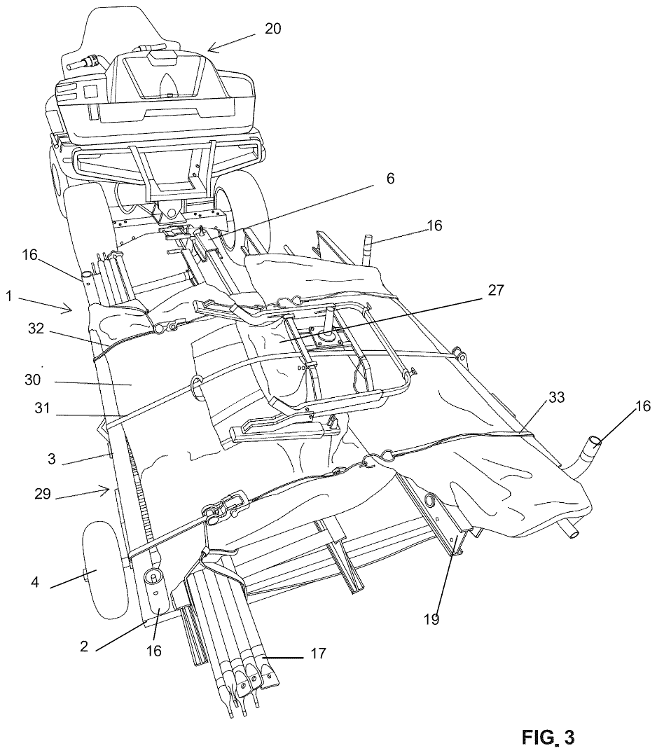

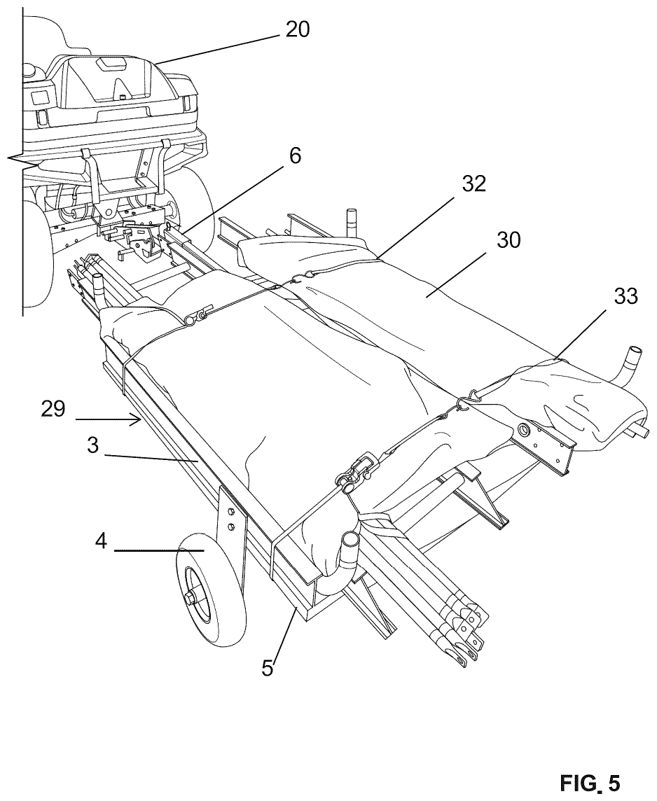

The mobile hunting stand 1 comprises a platform 2 supported by a frame 3. A set of wheels 4,5 operatively connected to the frame 3 are configured to be elevated off the ground when the frame 3 is in a first configuration as the hunting stand as shown in FIGS. 1 and 2, and to support the frame 3 when in a second configuration as the trailer as shown in FIGS. 3-5. A hitch mechanism 6 attached to the frame 3 allows for towing the trailer. The hitch mechanism 6 enables the mobile hunting stand 1 when in the second configuration to connect to an ATV 20 or other suitable vehicle, enabling the 5 mobile hunting stand 1 to be towed to different hunting locations. The hitch mechanism 6 is designed to be robust and secure, ensuring that the mobile hunting stand 1 remains attached to the ATV 20 during transportation. The mobile hunting stand in the second configuration i.e. converted into a trailer, provides a convenient means of transporting a harvested animal back to camp.

When in the first configuration as the hunting stand, the frame 3 positions the wheels 4,5 at an elevated height relative to the ground, ensuring compliance with hunting regulations. A plurality of adjustable legs 7, 8, 9, 10 are detachably connected to the frame 3 by quick-release pins (not shown) or other suitable fastener that enable rapid assembly and disassembly. Each of the adjustable legs, generally indicated at 7,8,9,10, has a connectable upper leg section 11, middle leg section 12 and lower leg section 13. The lower leg sections 13 each have an adjustable foot 14. The adjustable legs 7,8,9,10 connect to the frame 3 of the mobile hunting stand 1 at connection points 16 and provide stability on uneven ground. The adjustable legs 7,8,9,10 can be extended or retracted to level the platform 2, ensuring a stable and secure hunting position. The adjustable legs ensure that the mobile hunting stand can be set up in a variety of terrains, providing versatility and adaptability for the user. Weighted bags or other similar device can be attached to the lower leg sections 13 adjacent the adjustable foot 14 to provide greater stability. In one embodiment bags are filled with rocks gathered around where the mobile hunting stand is located to create the weighted bags.

The mobile hunting stand 1 includes cross support bars 17. The cross-support bars 17 connect to the adjustable legs 7,8,9,10 of the mobile hunting stand 1, providing additional stability and support. The cross-support bars 17 are designed to be strong and durable, ensuring that the mobile hunting stand remains stable and secure during use.

The platform 2 serves as the primary hunting area and supports the hunter during use. The platform 2 connects to the frame 3 of the mobile hunting stand and includes detachable safety rails 18. The platform is designed to be sturdy and durable, providing a secure and stable surface for the hunter. The safety rails can be used as a gun rail to provide a stable rest for the hunter's firearm. An adjustable ladder 19 is attachable to the frame 3 when in the first configuration in order to provide access to the platform 2. The ladder 19 may be made of the same material as the frame 3 and is designed to support the weight of a person climbing to the platform 2. The ladder 19 may include non-slip rungs to enhance safety. In the embodiment shown the ladder 19 is formed of two separate sections that are longitudinally connected (see FIG. 2). Alternatively, the ladder 19 can have sections that are extendible and retractable relative to each other.

The components of the mobile hunting stand 1, designed to be assembled into a hunting stand and disassembled into a trailer are constructed to provide structural integrity and support for both configurations. The components in the embodiment illustrated are made of lightweight aluminum, which provides a balance between strength and portability. This material choice allows for easy transportation and setup, while still offering the necessary durability to withstand outdoor conditions and the weight of the user and equipment.

In the disassembled configuration shown in FIGS. 3-5, the platform 2 is shown under frame 3. The set of wheels 4,5 are attached to the frame 3 perpendicular to platform 2 and extending down from the frame 3 to the ground. With the wheels in this orientation the platform/trailer doesn't need to be flipped over to install the adjustable legs. To assemble the components into the assembled configuration, one end 21 of each of the top leg sections 11 are connected to the frame 3 at connection points 16. A middle leg section 12 is then attached to each of the top leg sections and a lower leg section 13 then attached to each of the middle leg sections 12. The lower leg sections 13 each have an adjustable foot 14. The adjustable feet 14 are designed to be adjustable in length relative to the longitudinal axis of each leg 7,8,9,10, allowing the user to level the mobile hunting stand 1 on uneven terrain. Cross-support bars 17 are put in place extending from a lower end 22 of a top leg section 11 on one leg 7, 8, 9, 10 to a lower end 23 of an adjacent middle leg section 12 on another leg 7,8,9,10 forming an x-shaped support between adjacent pairs of legs 7,8,9,10.

In order to attach vertical supports 24 for the top safety rails 18 in designated holes in the top surface 25 of platform 2 the hunting stand 1 needs to be on its side on the ground. The top safety rails 18 are then installed at the end 26 of the vertical supports 25 remote from the top surface 25 of platform 2. A seat 27 may be connected to the top surface 25 of platform 2 to enable a hunter to be in a sitting position when using the mobile hunting stand 1 in the assembled configuration. The assembled mobile hunting stand 1 is unhitched from the ATV and is then lifted off the ground in order to be placed upright or it may also have a rope connection for an ATV winch to pull it upright slowly. Ladder 19 can then be placed against one side 28 of the platform 2 to allow access. In FIGS. 1 and 2, the mobile hunting stand 1 is shown in its fully assembled state, with the wheels 4,5 positioned alongside the hunter, 11 feet in the air. This configuration ensures that the mobile hunting stand remains stationary and stable during use.

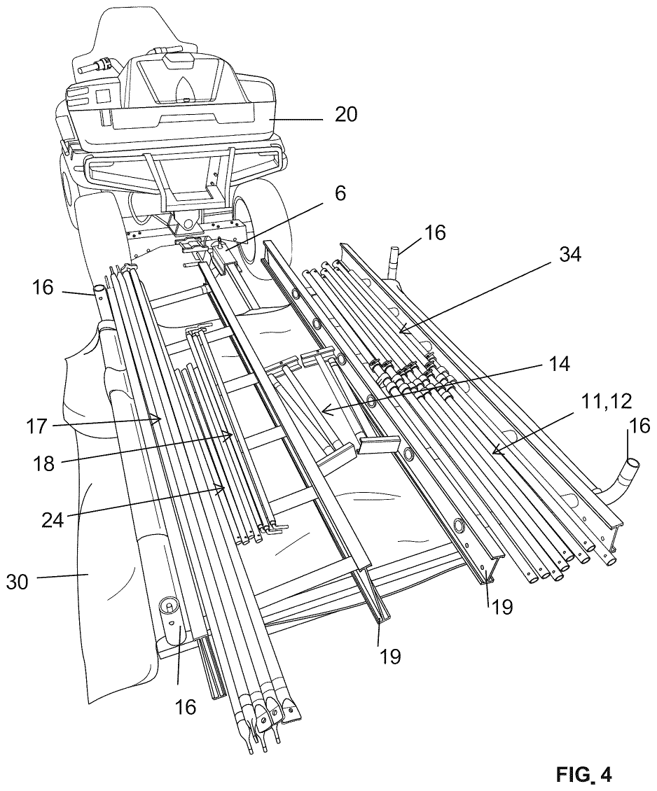

To convert the mobile hunting stand 1 from the assembled configuration upright on the ground as shown in FIGS. 1 & 2 to the disassembled configuration shown in FIGS. 3-5 the assembly process described above is reversed. First the ladder 19 is removed then the mobile hunting stand 1 is lowered so one side is on the ground. The top safety rails 18, vertical supports 24 and seat 27 can be disconnected. At this point the mobile hunting stand 1 can be re-oriented with wheels 4,5 resting on the ground and the hitch mechanism 6 re-connected to the ATV 20 or other towing vehicle. The cross-support bars 17 are disconnected and then each of the adjustable feet 14, lower leg sections 13, middle leg sections 12 and top leg sections 11 are disconnected. The platform 2 and frame 3 are now configured as a trailer 29. All of the disconnected components, generally indicated at 34, namely the ladder 19, top safety rails 18, vertical supports 5 24, seat 27, cross-support bars 17, adjustable feet 14, lower leg sections 13, middle leg sections 12 and top leg sections 11 can be placed on the trailer 29 as shown in FIGS. 3, 4 & 5. In FIGS. 3, 4 & 5 a tarp 30 and straps 31, 32, 33 are used to secure the components in place so they do not fall off.

While the principles of the invention have been shown and described in connection with specific embodiments, it is to be understood that such embodiments are by way of example and are not limiting as is evident from the foregoing description, certain aspects of the present invention are not limited by the particular details illustrated in the drawings. Other modifications and applications, or equivalents, will occur to those skilled in the art. The terms “having”, “comprising” and “including” and similar terms as used in the foregoing specification are used in the sense of “optional” or “may include” and not as “required”. Many changes, modifications, variations and other uses and applications of the present construction will, however, become apparent to those skilled in the art after considering the specification and attached drawings. All such changes, modifications, variations and other uses and applications which do not depart from the spirit and scope of the invention are deemed to be covered by the invention which is limited only by the claims that follow. The scope of the disclosure is not intended to be limited to the embodiments shown herein, but is to be accorded the full scope consistent with the claims, wherein reference to an element in the singular is not intended to mean “one and only one” unless specifically so stated, but rather one or more. All structural and functional equivalents to the elements of the embodiment described throughout the disclosure that are known or later come to be known to those of ordinary skill in the art are expressly incorporated herein by reference and intended to be encompassed by the claims.

1. A mobile hunting stand convertible from a disassembled configuration in the form of trailer and an assembled configuration as an elevated hunting platform, comprising:
a platform supported by a frame, a set of wheels operatively connected to the frame and configured to be elevated off the ground when the platform and frame are in an assembled configuration as the hunting stand, and to support the frame when in a disassembled configuration as a trailer;
a hitch mechanism attached to the frame for connection to a vehicle for towing the mobile hunting stand in the disassembled configuration;
a plurality of adjustable legs detachably connectable to the frame to enable rapid assembly and disassembly; and
an adjustable ladder attachable to the frame when in the assembled configuration in order to provide access to the platform.

2. The mobile hunting stand of claim 1, wherein the frame is made of lightweight aluminum.

3. The mobile hunting stand of claim 1, wherein the frame includes quick-release pins for rapid assembly and disassembly.

4. The mobile hunting stand of claim 1, wherein the frame includes cross-bracing for additional stability when used as a hunting stand.

5. The mobile hunting stand of claim 1, wherein the wheels are all-terrain to navigate various types of ground.
